(19) United States
(12) Patent Application Publication
(10) Pub. No.: US 2015/0227221 A1
(43) Pub. Date: Aug. 13, 2015

(54) MOBILE TERMINAL DEVICE, ON-VEHICLE DEVICE, AND ON-VEHICLE SYSTEM

(71) Applicants: Seiichi Tsunoda, Nisshin-shi (JP); Daiki Isogai, Togo-cho (JP); Yasutomo Kato, Toyota-shi (JP)

(72) Inventors: Seiichi Tsunoda, Nisshin-shi (JP); Daiki Isogai, Togo-cho (JP); Yasutomo Kato, Toyota-shi (JP)

(73) Assignee: TOYOTA JIDOSHA KABUSHIKI KAISHA, Toyota-shi, Aichi (JP)

(21) Appl. No.: 14/425,388

(22) PCT Filed: Sep. 12, 2012
(86) PCT No.: PCT/JP2012/073375

§ 371 Date: Mar. 3, 2015

(51) Int. Cl. G06F 3/041; B60R 11/00

(52) U.S. Cl. CPC G06F 3/041; B60R 11/00

(57) ABSTRACT

A mobile terminal device 40 according to an embodiment of the present invention includes a touch panel 3 and a control device 1 which causes the touch panel 3 to function as a touch pad for operating an operation object displayed on a display device 6V when it is placed at a predetermined position in a vehicle interior. The touch panel 3 functions as a multi-touch type touch pad. The control device 1 switches operation objects depending on a number of fingers used for performing a touch gesture on the touch panel 3. The operation objects include a cursor, a map image, and a widget screen.

### TECHNICAL FIELD

The present invention relates to a mobile terminal device, an on-vehicle device working together with the mobile terminal device, and an on-vehicle system causing the mobile terminal device and the on-vehicle device to work together.

### BACKGROUND ART

Conventionally, an on-vehicle system has been known which connects a mobile terminal device brought into a vehicle interior and an on-vehicle device via a Near Field Communication line (for example, see Patent Document 1).

This on-vehicle system causes the mobile terminal device to serve as a pointing device in relation to an on-vehicle display with the mobile terminal device and the on-vehicle device connected via the Near Field Communication line. Specifically, the on-vehicle system causes the mobile terminal device to serve as the pointing device by capturing a display image on the on-vehicle display via a camera attached to the mobile terminal device, by determining which part of the display image the captured image corresponds to, and by using the determination result for specifying an input position.

### RELATED-ART DOCUMENTS

### Patent Documents

### [Patent Document 1]

Japanese Laid-open Patent Publication No. 2008-191868

### SUMMARY OF THE INVENTION

### Problem to be Solved by Invention

However, in the on-vehicle system of the Patent Document 1, an operator is forced to perform a cumbersome operation because the operator needs to operate the mobile terminal device with it in hand in order to capture the screen of the on-vehicle display via the camera attached to the mobile terminal device.

In view of the above, it is an object of the present invention to provide a mobile terminal device which enables easier operation of an operation object displayed on an on-vehicle display, an on-vehicle device which cooperates with the mobile terminal device, and an on-vehicle system which causes the mobile terminal device and the on-vehicle device to work together.

### Means to Solve the Problem

In order to achieve the above object, a mobile terminal device according to an embodiment of the present invention is provided with a touch panel and a control device which causes the touch panel to function as a touch pad for operating an operation object displayed on an on-vehicle display when the mobile terminal device is placed at a predetermined position in a vehicle interior.

Also, an on-vehicle device according to an embodiment of the present invention is connected to an on-vehicle display and receives an operation input to a touch panel of a mobile terminal device placed at a predetermined position in a vehicle interior as an operation input to an operation object displayed on the on-vehicle display.

Also, an on-vehicle system according to an embodiment of the present invention includes a mobile terminal device provided with a control device which causes a touch panel to function as a touch pad for operating an operation object displayed on an on-vehicle display when the mobile terminal device is placed at a predetermined position in a vehicle interior, and an on-vehicle device which receives an operation input to the touch panel of the mobile terminal device placed at the predetermined position in the vehicle interior as an operation input to an operation object displayed on the on-vehicle display.

### Advantage of the Invention

According to the above means, the present invention can provide a mobile terminal device which enables easier operation of an operation object displayed on an on-vehicle display, an on-vehicle device which cooperates with the mobile terminal device, and an on-vehicle system which causes the mobile terminal device and the on-vehicle device to work together.

### BRIEF DESCRIPTION OF DRAWINGS

FIG. 1 is a functional block diagram illustrating a configuration example of a mobile terminal device according to an embodiment of the present invention;

FIG. 2 is a front view of the mobile terminal device in FIG. 1;

FIG. 3 is a diagram illustrating a picture of a vehicle interior when the mobile terminal device in FIG. 1 has been docked in a dock on a dashboard;

FIG. 4 is a flowchart illustrating a flow of a terminal state switchover processing;

FIG. 5 is a flowchart illustrating an operation object switchover processing;

FIG. 6 is a diagram illustrating the relationship between contents of a touch gesture performed with one finger and a change in a displayed image;

FIG. 7 is a diagram illustrating the relationship between contents of a touch gesture performed with two fingers and a change in a displayed image; and

FIG. 8 is a diagram illustrating the relationship between contents of a touch gesture performed with three fingers and a change in a displayed image.

### MODE FOR CARRYING OUT THE INVENTION

In the following, modes for carrying out the present invention will be described with reference to the drawings.

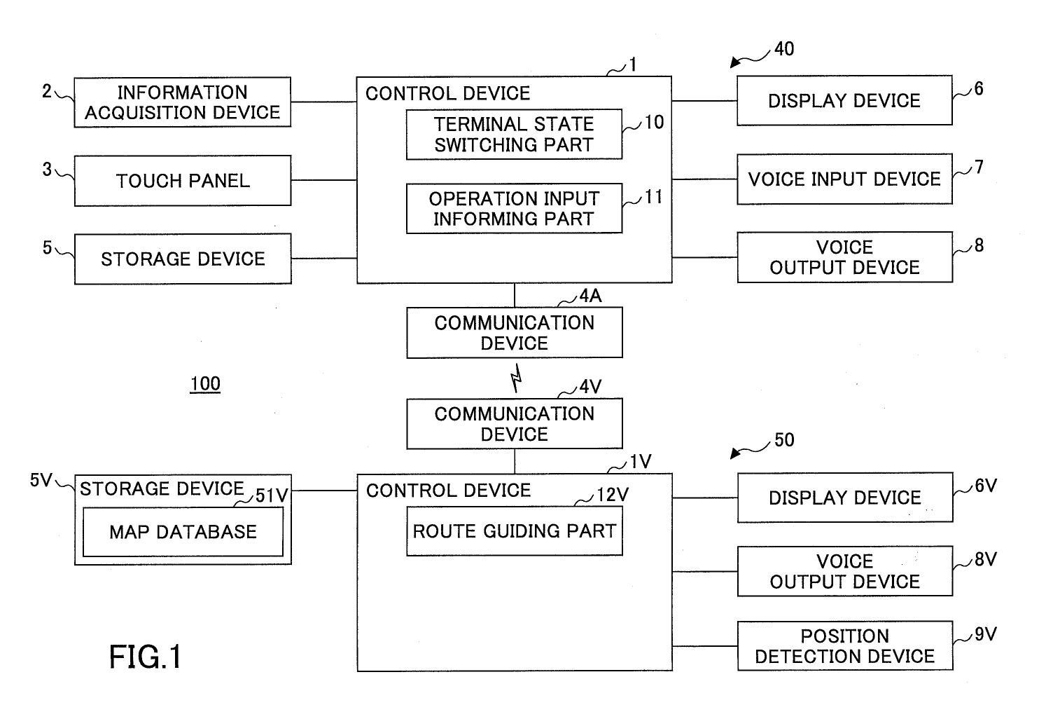

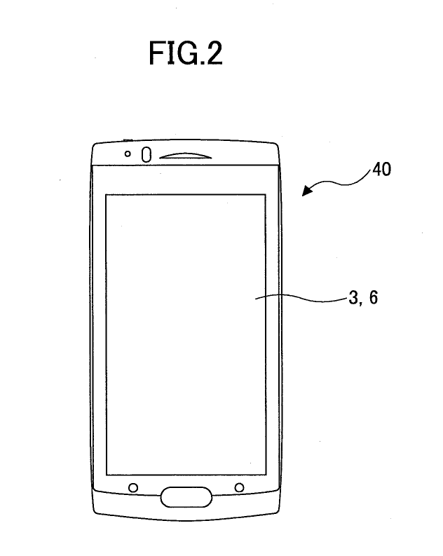

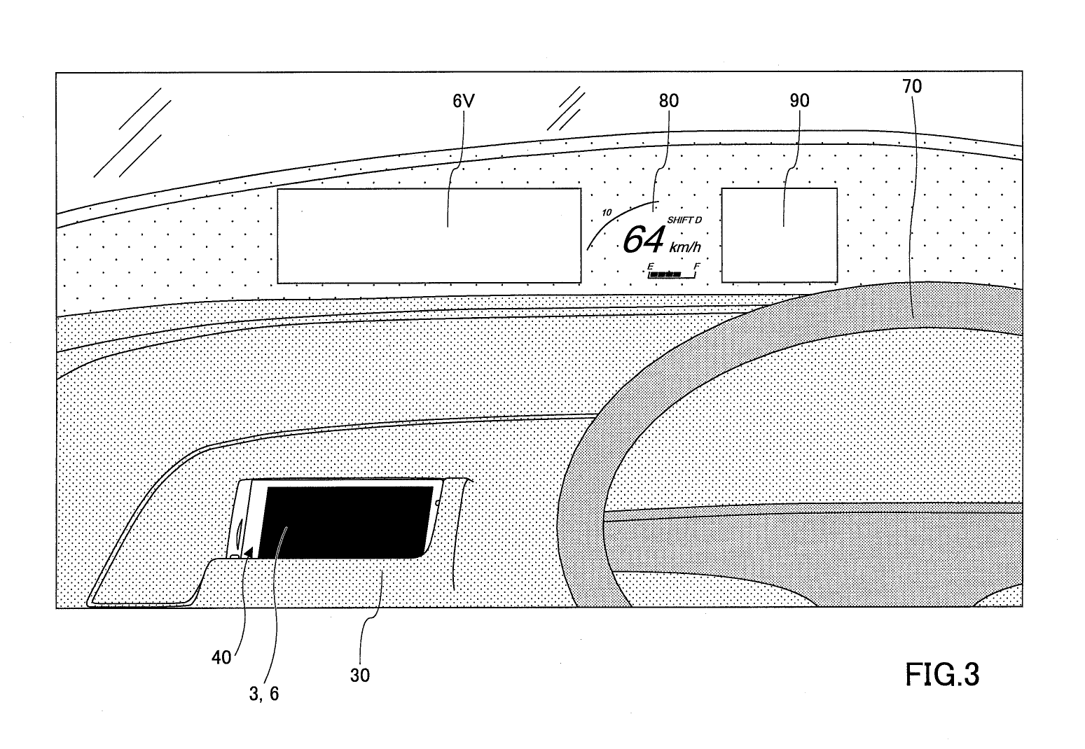

FIG. 1 is a functional block diagram illustrating a configuration example of an on-vehicle system 100 including a mobile terminal device 40 according to an embodiment of the present invention. Also, FIG. 2 is a front view of the mobile terminal device 40, and FIG. 3 is a diagram illustrating a picture of a vehicle interior when the mobile terminal device 40 has been docked in a cradle (a dock) 30 on a dashboard.

The on-vehicle system 100 causes the mobile terminal device 40 and an on-vehicle device to work together. The on-vehicle system 100 mainly includes the mobile terminal device 40 and the on-vehicle device 50.

The mobile terminal device 40 is a terminal device carried by an occupant. For example, the mobile terminal device includes a mobile phone, a smartphone, a Personal Digital Assistant (PDA), a portable game device, a tablet computer, or the like. In the present embodiment, the mobile terminal device 40 is a smartphone. The mobile terminal device 40 mainly includes a control device 1, an information acquisition device 2, a touch panel 3, a communication device 4, a storage device 5, a display device 6, a voice input device 7, and a voice output device 8.

The control device 1 controls the mobile terminal device 40. In the present embodiment, the control device 1 is a computer provided with a Central Processing Unit (CPU), a Random Access Memory (RAM), a Read-Only Memory (ROM), or the like. For, example, the control device 1 reads out a program corresponding to each of after-mentioned functional elements such as a terminal state switching part 10 and an operation input informing part 11, loads it into the RAM, and causes the CPU to perform a procedure corresponding to each of the functional elements. The program corresponding to each of the functional elements may be downloaded via a communication network or may be provided as being stored in a storage medium.

The information acquisition device 2 acquires a piece of information from outside. In the present embodiment, the information acquisition device 2 is a wireless communication device for a mobile phone communication network, a public wireless LAN, or the like.

The touch panel 3 is one of operation input devices Mounted on the mobile terminal device 40. For example, the touch panel 3 is a multi-touch type touch panel located on the display device 6 and supports a multi-touch gesture function.

The communication device 4 controls a communication with the on-vehicle device 50. In the present embodiment, the communication device 4 is connected to a communication device 4V in the on-vehicle device 50 via Near Field Communication (hereinafter referred to as “NFC”). A wireless communication based on the Bluetooth (registered trademark), the Wi-Fi (registered trademark), or the like may be used for the communication between the communication device 4 and the communication device 4V. A wired communication based on the Universal Serial Bus (USB) or the like may be used for the communication.

In the present embodiment, the communication device 4 transmits a reply request signal periodically. The communication device 4V sends back a reply signal to the communication device 4 upon receiving the reply request signal. Then, the communication device 4 establishes a wireless communication with the communication device 4V upon receiving the reply signal. Alternatively, the communication device 4V may transmit a reply request signal periodically or each of the communication device 4 and the communication device 4V may transmit a reply request signal periodically. In this case, the communication device 4 sends back a reply signal to the communication device 4V upon receiving the reply request signal. Then, the communication device 4V establishes a wireless communication with the communication device 4 upon receiving the reply signal. Then, the communication device 4 outputs to the control device 1 a control signal informing that a wireless communication with the communication device 4V has been established when the wireless communication with the communication device 4V has been established.

FIG. 3 illustrates a state where the mobile terminal device 40 is docked in a dock 30 as an example of a state where a wireless communication has been established between the mobile terminal device 40 and the on-vehicle device 50. As shown in FIG. 3, the mobile terminal device 40 is held by the dock 30 with the touch panel 3 and the display device 6 directed to a driver.

By this configuration, the driver can, for example, conduct an operation input to the touch panel 3 by stretching his/her hand placed on a steering wheel 70. Also, if necessary, the driver can see, while driving, the display device 6V which displays navigation information, a speedometer 80 which displays speed information, and a multi information display 90 which displays a communication state of the mobile terminal device 40, a battery state, or the like.

The storage device 5 stores various pieces of information. For example, the storage device 5 includes a non-volatile semiconductor memory such as a flash memory. In the present embodiment, the storage device 5 stores an application software (hereinafter referred to as “APP”), a widget, or the like which is executed on the mobile terminal device 40.

A “widget” is a small-scale accessory APP running on the mobile terminal device 40. For example, the widget is an APP which acquires a new piece of information at regular intervals and displays it. Specifically, the widget includes an APP which displays stock price information, weather forecast, altitude, coastal wave forecast, or the like. Also, the widget includes an APP which displays calendar, clock time, etc., a slide show APP which sequentially displays images of a surrounding area of a vehicle obtained from a website, an APP which displays a degree of eco-driving based on pieces of vehicle operating information, or the like. The widget may be downloaded via a communication network or may be provided as being stored in a storage medium.

The display device 6 displays various pieces of information. For example, the display device 6 is a liquid crystal display. The voice input device 7 is a device for inputting a voice. For example, the voice input device 7 is a microphone. The voice output device 8 outputs various pieces of audio information. For example, the audio output device 8 is a speaker.

Next, the on-vehicle device 50 will be described. For example, the on-vehicle device 50 is an on-vehicle navigation device. The on-vehicle device 50 mainly includes a control device 1V, a storage device 5V, a display device 6V, a voice output device 8V, and a position detection device 9V.

The control device 1V controls the on-vehicle device 50. In the present embodiment, the control device 1V is a computer provided with a CPU, a RAM, a ROM, or the like. For example, the control device 1V reads out a program corresponding to an after-mentioned route guiding part 12V, loads it into the RAM, and causes the CPU to perform a procedure corresponding to the route guiding part 12V. The program corresponding to the route guiding part 12V may be downloaded via a communication network or may be provided as being stored in a storage medium.

The storage device 5V stores various pieces of information. For example, the storage device 5V includes a non-volatile semiconductor memory such as a flash memory. In the present embodiment, the storage device 5V stores a map database 51V. The map database 51V systematically stores a position of a node such as an intersection, an interchange, or the like, a length of a link as an element connecting two nodes, a time required for passing through a link, a link cost indicating the degree of traffic expense or the like, a facility position (latitude, longitude, altitude), a facility name, or the like.

The display device 6V displays various pieces of information. For example, the display device 6V is a liquid crystal display. The voice output device 8V outputs various pieces of audio information. For example, the audio output device 8V is a speaker.

The position detection device 9V detects a position of the on-vehicle device 50. In the present embodiment, the position detection device 9V is a Global Positioning System (GPS) receiver which receives a GPS signal from a GPS satellite via a GPS antenna. The position detection device 9V detects a position (latitude, longitude, altitude) of the on-vehicle device 50 based on the received GPS signal, and outputs the detection result to the control device 1V.

Next, various functional elements in the control device 1 of the mobile terminal device 40 will be described.

The terminal state switching part 10 is a functional element which switches operating states of the mobile terminal device 40. For example, the terminal state switching part 10 switches an operating state where the mobile terminal device 40 functions as a normal mobile terminal device (hereinafter referred to as “normal mode”) to an operating state where the mobile terminal device 40 functions as an operation input device for the on-vehicle device 50 (hereinafter referred to as “input mode”) when the mobile terminal device 40 has been placed at a predetermined position in a vehicle interior.

A “predetermined position in a vehicle interior” is a position within a range where the communication between the mobile terminal device 40 and the on-vehicle device 50 is available. For example, it is a position within a predetermined range around a driver's seat.

In the present embodiment, the terminal state switching part 10 switches the normal mode and the input mode based on the output of the communication device 4. Specifically, the terminal state switching part 10 changes the operating state of the mobile terminal device 40 to the input mode when it detects that the wireless communication is being established between the mobile terminal device 40 and the on-vehicle device 50. In contrast, the terminal state switching part 10 changes the operating state of the mobile terminal device 40 to the normal mode when it detects that the wireless communication is not being established between the mobile terminal device 40 and the on-vehicle device 50.

More specifically, the terminal state switching part 10 changes the operating state of the mobile terminal device 40 to the input mode by automatically booting up a predetermined APP when it detects that the mobile terminal device 40 has been docked in the dock 30 and the wireless communication has been established. Also, the terminal state switching part 10 changes the operating state of the mobile terminal device 40 to the normal mode by automatically terminating the predetermined APP when it detects that the mobile terminal device 40 has been detached from the dock 30 and the wireless communication has been lost. Also, the terminal state switching part 10 may only have to make the predetermined APP bootable or terminable without automatically booting or terminating the predetermined APP in the case of mode switching so that the terminal state switching part 10 can switch the operating state of the mobile terminal device 40 in response to the boot up or the termination of the predetermined APP achieved by the operator's manual operation.

A “predetermined APP” is an APP running on the mobile terminal device 40. For example, the predetermined APP includes an operation input APP relating to an operation input. In particular, the predetermined APP includes a touch gesture recognition APP which recognizes various touch gestures. A touch gesture is an action for performing an operation input on the touch panel 3 by using movement of a finger or the like. For example, the touch gesture includes a tap, a double tap, a drag, a swipe, a flick, a pinch in, a pinch out, or the like.

FIG. 3 shows a state where an image of touch pad (an image of a black color touch pad surface) is displayed as a screen for the touch gesture recognition APP on the display device 6 of the mobile terminal device 40. However, when the mobile terminal device 40 has been docked in the dock 30, the mobile terminal device 40 may halt displaying a screen image on the display device 6 after booting up the touch gesture recognition APP, i.e., after making an operator's operation input to the touch panel 3 acceptable.

As used herein, a “touch panel” represents an operation input device located on a display device and working together with the display device (an operation input device for operating an operation object displayed on the display device). A “touch pad” represents an operation input device located away from a display device and working together with the display device. Thus, the touch panel 3 functions as a touch panel in relationship with the display device 6, while the touch panel 3 functions as a touch pad in relationship with the display device 6V. This is because the display device 6 is located integrally with the touch panel 3 while the display device 6V is located away from the touch panel 3.

The operation input informing part 11 is a functional element which informs the on-vehicle device 50 of contents of an operation input performed by an operator to an operation input device of the mobile terminal device 40. In the present embodiment, the operation input informing part 11 is a touch gesture recognition APP. The operation input informing part 11 informs the on-vehicle device 50 of contents of a touch gesture performed by an operator to the touch panel 3.

Also, in the present embodiment, the operation input informing part 11 switches operation objects depending on a number of fingers used for a touch gesture. An “operation object” is an image on an on-vehicle display operated by an operator through the operation input device. Specifically, in a case where a touch gesture is performed with one finger, the operation input informing part 11 sends a predetermined operation input information to the on-vehicle device 50 so that a cursor displayed on the display device 6V may be set as an operation object. More specifically, the operation input informing part 11 sends a predetermined operation input information to the on-vehicle device 50 so that a cursor movement, selection by the cursor, or the like may be performed. An operation input information is a piece of information representing contents of an operation input by an operator to the touch panel 3. For example, an operation input information includes an identification number of an operation object, a displacement amount of an operation object, a displacement speed of an operation object, a displacement direction of an operation object, or the like.

Also, in a case where a touch gesture is performed with two fingers, the operation input informing part 11 sends a predetermined operation input information to the on-vehicle device 50 so that an image of a specific APP displayed on the display device 6V may be set as an operation object. More specifically, the operation input informing part 11 sends a predetermined operation input information to the on-vehicle device 50 so that a scroll operation, a zoom-in operation, a zoom-out operation, or the like, of a map image of a navigation APP may be performed.

Also, in a case where a touch gesture is performed with three fingers, the operation input informing part 11 sends a predetermined operation input information to the on-vehicle device 50 so that a widget screen displayed on the display device 6V may be set as an operation object. More specifically, the operation input informing part 11 sends a predetermined operation input information to the on-vehicle device 50 so that a switch between a visible state and a hidden state of a widget screen displayed on the display device 6V, a switch between widget screens displayed on the display device 6V, or the like, may be performed. A widget screen is a screen which a widget displays on a part of an image region of the display device 6V.

Also, in the present embodiment, an operation object is set depending on a number of fingers in the case where a touch gesture is performed with one, two, or three fingers. However, an operation object may be set depending on a number of fingers in the case where a touch gesture is performed with more than three fingers.

Next, the route guiding part 12V as a functional element in the control device 1V of the on-vehicle device 50 will be described.

The route guiding part 12V is a functional element which guides a route to a predetermined point. For example, the route guiding part 12V executes an APP for navigation. In the present embodiment, the route guiding part 12V selects out an optimal route from a current position to a destination position based on the current position detected by the position detection device 9V, the destination position entered through the touch panel of the mobile terminal device 40, and the map database 51V stored in the storage device 5V.

Also, the route guiding part 12V searches a shortest path by using, for example, the Dijkstra's algorithm as a shortest path search algorithm. Also, the route guiding part 12V may search a fastest route allowing the earliest arrival at a destination, a route not including an expressway, or the like, other than the shortest route.

Also, the route guiding part 12V displays on the display device 6V a searched recommended route distinguishably from other routes so that an operator can easily recognize the recommended route. Also, the route guiding part 12V assists the operator in driving along the recommended route by causing the voice output device 8V to output a voice guide.

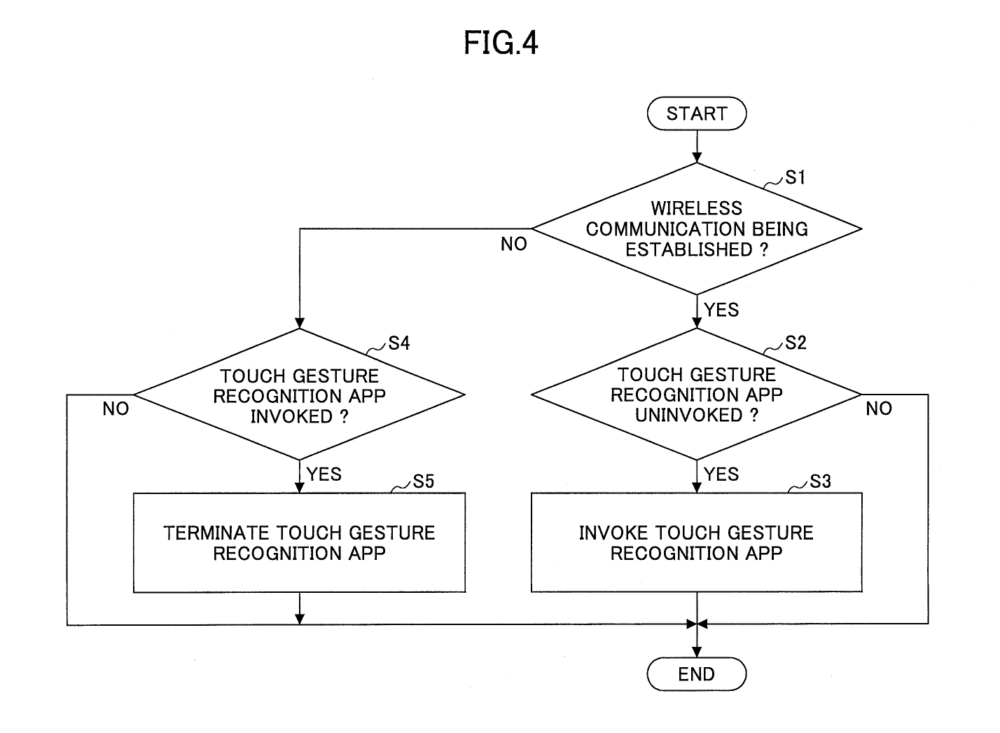

Next, referring to FIG. 4, a procedure in which the mobile terminal device 40 switches its own operating states (hereinafter referred to as “terminal state switching procedure”) will be described. FIG. 4 is a flowchart illustrating a flow of the terminal state switching procedure. The mobile terminal device 40 repeatedly executes this terminal state switching procedure at a predetermined frequency.

First, the terminal state switching part in the control device 1 of the mobile terminal device 40 determines whether a wireless communication is being established between the mobile terminal device 40 and the on-vehicle device (step S1). In the present embodiment, the terminal state switching part 10 determines whether a NFC wireless communication is being established between the communication device 4 mounted on the mobile terminal device 40 and the communication device 4V of the on-vehicle device 50, based on the output of the communication device 4.

If the terminal state switching part 10 determines that the wireless communication is being established (YES in step S1), the terminal state switching part 10 determines whether a predetermined APP is uninvoked or not (step S2). In the present embodiment, the terminal state switching part 10 determines whether a touch gesture recognition APP is uninvoked or not.

If the terminal state switching part 10 determines that the touch gesture recognition APP is uninvoked (YES in step S2), the terminal state switching part 10 invokes the touch gesture recognition APP (step S3). In this way, the terminal state switching part 10 switches operating states of the mobile terminal device 40 to the input mode. If the terminal state switching part 10 determines that the touch gesture recognition APP has already been invoked (NO in step S2), the terminal state switching part 10 keeps the operating state (the input mode) of the mobile terminal device 40 as it is.

In contrast, if the terminal state switching part 10 determines that the wireless communication is not being established (NO in step S1), the terminal state switching part 10 determines whether the predetermined APP has already been invoked or not (step S4). In the present embodiment, the control device 1 determines whether the touch gesture recognition APP has already been invoked or not.

If the terminal state switching part 10 determines that the touch gesture recognition APP has already been invoked (YES in step S4), the terminal state switching part 10 terminates the touch gesture recognition APP (step S5). In this way, the terminal state switching part 10 switches operating states of the mobile terminal device 40 to the normal mode. If the terminal state switching part 10 determines that the touch gesture recognition APP is uninvoked (NO in step S4), the terminal state switching part 10 keeps the operating state (the normal mode) of the mobile terminal device 40 as it is.

In this way, the mobile terminal device 40 can switch its own operating states automatically depending on whether the wireless communication is being established between itself and the on-vehicle device 50.

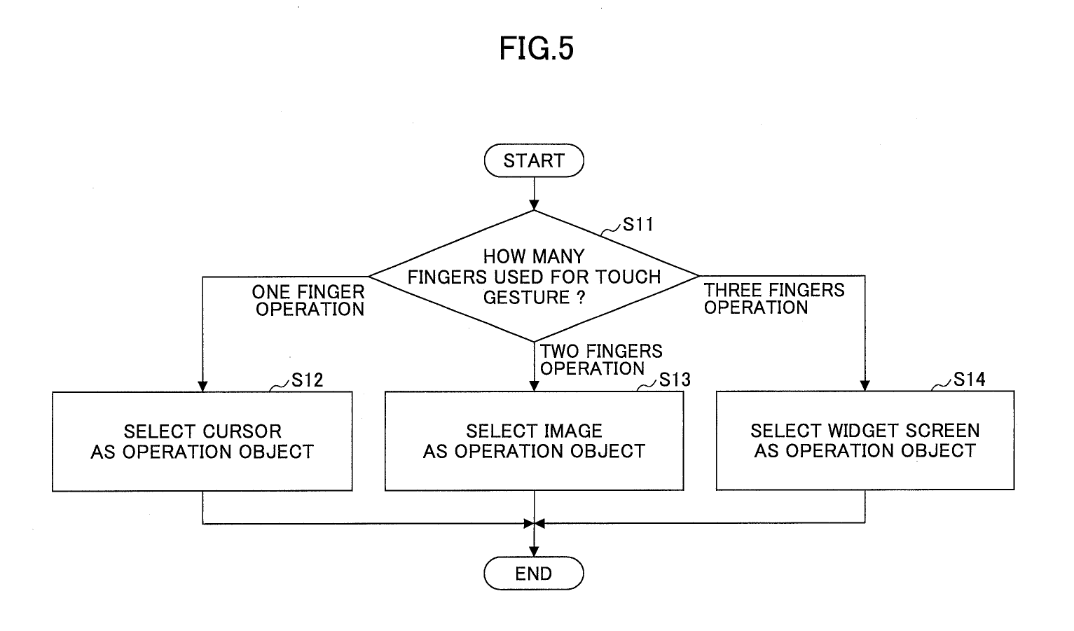

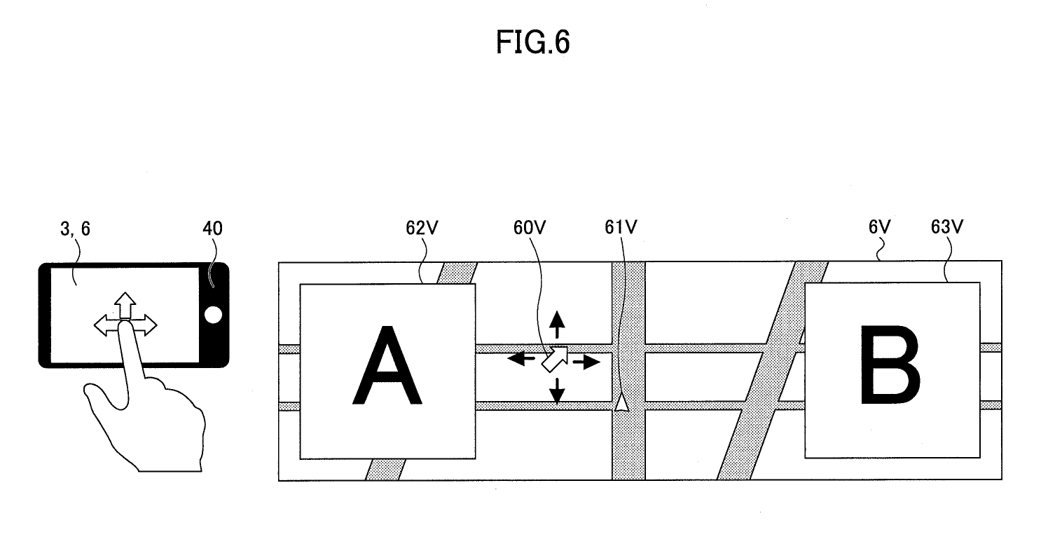

Next, referring to FIGS. 5-8, a procedure for selecting operation objects depending on the contents of an operation input by an operator to the mobile terminal device 40 operating in the input mode (hereinafter referred to as “operation object selecting procedure”) will be described. FIG. 5 is a flowchart illustrating a flow of the operation object selecting procedure. The mobile terminal device 40 executes this operation object selecting procedure each time an operation input is conducted. Also, FIGS. 6-8 are diagrams illustrating relationship between contents of a touch gesture performed in relation to the touch panel 3 of the mobile terminal device 40 and a change in a displayed image on the display device 6V.

First, the operation input informing part in the control device 1 of the mobile terminal device 40 detects a number of operation points of a touch gesture (a number of fingers used for a touch gesture) (step S11).

If the number of fingers is one (ONE FINGER OPERATION in step S11), the operation input informing part 11 selects a cursor 60V as an operation object (step S12).

FIG. 6 is a diagram illustrating a relationship between contents of a touch gesture performed with one finger and a change in a displayed image. A left graphic illustrates contents of a touch gesture. A right graphic illustrates contents of a displayed image on the display device 6V. Also, as shown in the right graphic of FIG. 6, the displayed image on the display device 6V includes the cursor 60V, a vehicle position icon 61V, and widget screens 62V, 63V. In the present embodiment, the widget screens 62V, 63V are overlaid on a map image, and the cursor 60V is displayed so that it can get across the entire displayed image. Also, the right graphic of FIG. 6 shows a state where an image “A” related to a first widget is displayed on the widget display 62V and where an image “B” related to a second widget is displayed on the widget screen 63V.

In a case where a drag operation with one finger is performed as shown in the left graphic of FIG. 6, the cursor 60V moves in response to the drag operation as shown in the right graphic of FIG. 6. However, in the present embodiment, even if the cursor 60V has been moved by the drag operation with one finger, the map image and positions of the widget screens 62V, 63V remain unchanged. This is because the cursor 60V is being set as an operation object.

Also, in a case where a tap operation, a double tap operation, or the like, with one finger is performed, various functions in relation to a position on the displayed image specified by the cursor 60 are executed.

If the number of fingers is two (TWO FINGERS OPERATION in step S11), the operation input informing part 11 selects an image as an operation object (step S13). In the present embodiment, the operation input informing part 11 selects a map image as an operation object.

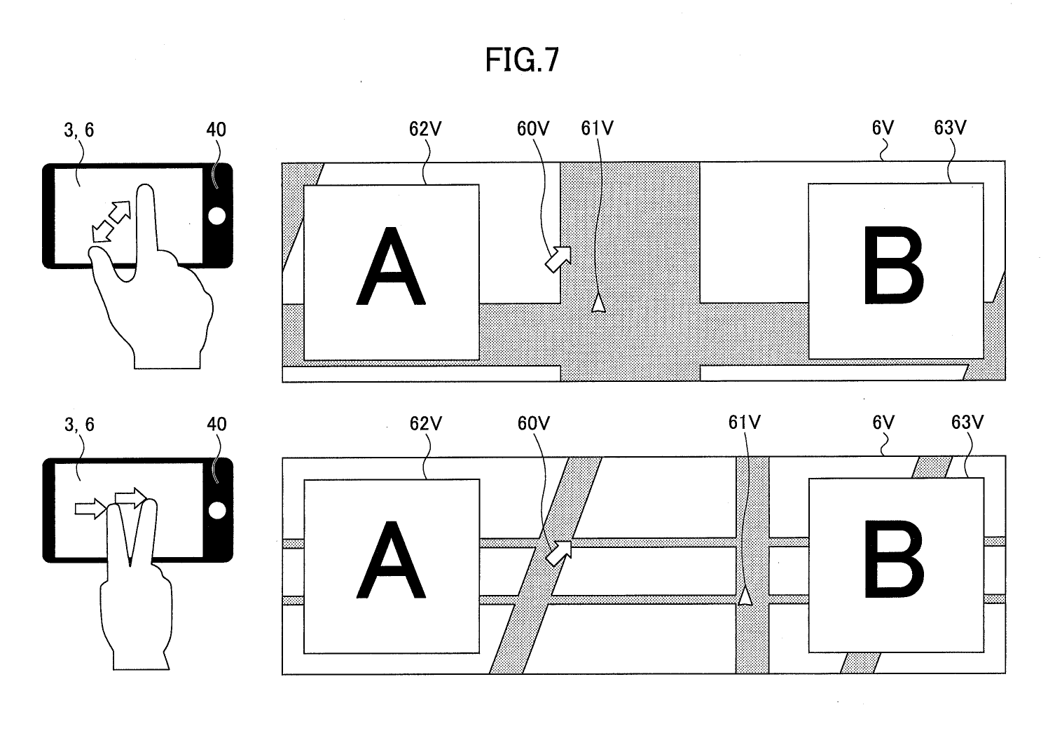

FIG. 7 illustrates a relationship between contents of a touch gesture performed with two fingers and a change in a displayed image. Left graphics of upper and lower figures illustrate contents of a touch gesture. Right graphics of the upper and lower figures illustrate contents of a displayed image on the display device 6V.

In a case where a pinch out operation with two fingers is performed as shown in the left graphic of the upper figure in FIG. 7, a map image is zoomed in as shown in the right graphic of the upper figure in FIG. 7. However, in the present embodiment, even if the map image has been zoomed in by the pinch out operation with two fingers, a position of the cursor 60V and positions of the widget screens 62V, 63V remain unchanged. This is because the map image is being set as an operation object. The same goes for a case where the map image is zoomed out by a pinch in operation with two fingers.

Also, in a case where a rightward drag operation with two fingers is performed as shown in the left graphic of the lower figure in FIG. 7, a map image is scrolled rightward as shown in the right graphic of the lower figure in FIG. 7. However, in the present embodiment, even if the map image has been scrolled by the drag operation with two fingers, a position of the cursor 60V and positions of the widget screens 62V, 63V remain unchanged. This is because the map image is being set as an operation object. The same goes for a case where drag operations in other directions with two fingers are performed.

If the number of fingers is three (THREE FINGERS OPERATION in step S11), the operation input informing part 11 selects a widget screen as an operation object (step S14).

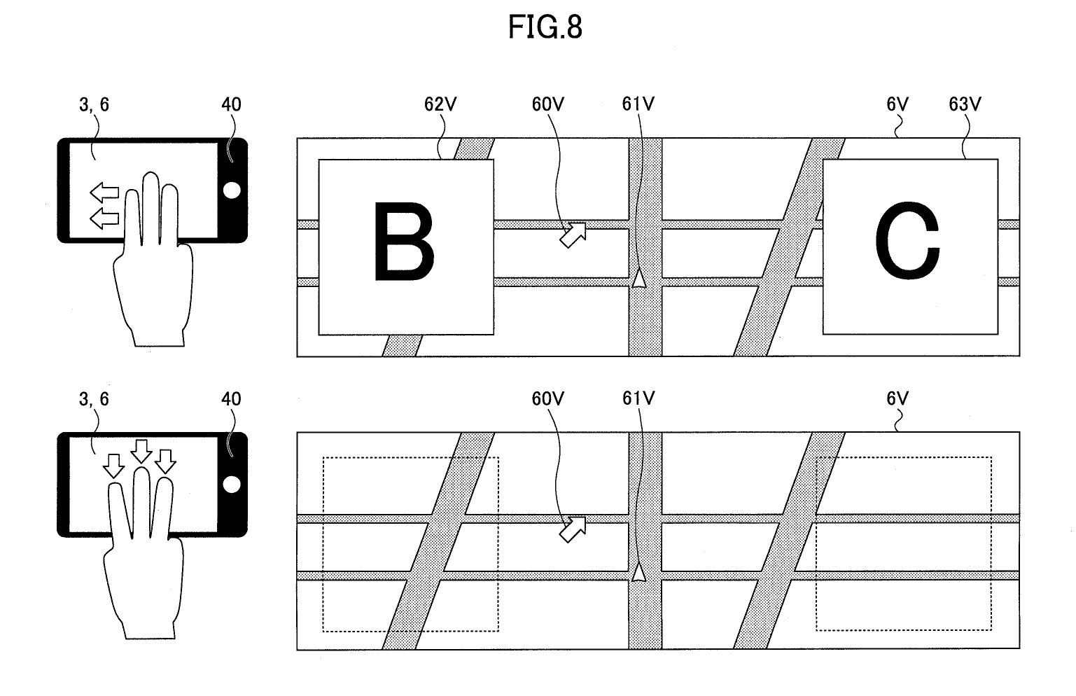

FIG. 8 illustrates a relationship between contents of a touch gesture performed with three fingers and a change in a displayed image. Left graphics of upper and lower figures illustrate contents of a touch gesture. Right graphics of upper and lower figures contents of a displayed image on the display device 6V.

In a case where a leftward swipe operation or a leftward flick operation with three fingers is performed as shown in the left graphic of the upper figure in FIG. 8, contents of a widget screen are switched as shown in the right graphic of the upper figure in FIG. 8. Specifically, the image “B” related to the second widget is displayed on the widget screen 62V on which the image “A” related to the first widget has been displayed. Also, an image “C” related to a third widget is newly displayed on the widget screen 63V on which the image “B” related to the second widget has been displayed. However, in the present embodiment, even if the contents of the widget screens has been switched by the leftward swipe operation or the leftward flick operation with three fingers, a position of the cursor 60V and the map image remain unchanged. This is because the widget screens are being set as an operation object. The same goes for a case where contents of the widget screens are switched by a rightward swipe operation or a rightward flick operation with three fingers.

Also, in a case where a downward swipe operation or a downward flick operation with three fingers is performed as shown in the left graphic of the lower figures in FIG. 8, visible/hidden of the widget screens is switched as shown in the right graphic of the lower figures in FIG. 8. Specifically, the widget screen 62V on which the image “A” related to the first widget has been displayed and the widget screen 63V on which the image “B” related to the second widget has been displayed are switched to a hidden state, thus a visible area of the map image is increased. For the purpose of illustration, the right graphic of the lower figure in FIG. 8 shows the hidden widget screens 62V, 63V with dashed lines. However, these dashed lines are not displayed in practice. Also, the hidden widget screens 62V, 63V return to a visible state when another downward swipe operation or another downward flick operation with three fingers is performed again. However, in the present embodiment, even if visible/hidden of the widget screens has been switched by the downward swipe operation or the downward flick operation with three fingers, a position of the cursor 60V and the map image remain unchanged. This is because the widget screens are being set as an operation object.

By the above configuration, the mobile terminal device 40 allows its own touch panel 3 to function as a touch pad for the on-vehicle device 50 without forcing an operator to perform a troublesome operation. Thus, the operator can operate an operation object displayed on the on-vehicle display more easily. Also, a pre-installed operation input device such as a touch panel can be omitted from the on-vehicle device 50. However, it is not necessary to omit the pre-installed operation input device such as the touch panel.

Also, the operator can select a desired operation object out of a plurality of operation objects displayed on the display device 6 by changing a number of fingers used for performing a touch gesture. Thus, the operator can perform an operation input to a desired operation object without keeping a close watch on the display device 6V. This is because the operator has to keep a close watch on a displayed image to precisely specify an operation object on the displayed image unless the operator can select an operation object by changing a number of fingers.

The preferable embodiments of the present invention have been described in detail as above. However, it should be understood that various alternations and substitutions could be made to the above embodiments without being limited by the above embodiments and without departing from the scope of the invention.

For example, in the above embodiments, the on-vehicle system 100 causes the route guiding part 12V in the control device 1V of the on-vehicle device 50 to execute a route guidance. However, the on-vehicle system 100 may cause a route guiding part (not shown) in the control device 1V of the mobile terminal device 40 to execute the route guidance. In this case, the route guiding part of the mobile terminal device 40 may use any of a map database (not shown) stored in the storage device 5 and the map database 51V stored in the storage device 5V of the on-vehicle device 50. Also, the route guiding part of the mobile terminal device 40 may use any of an output of a position detection device (not shown) mounted thereon and an output of the position detection device 9V mounted on the on-vehicle device 50.

Also, in the above embodiments, the mobile terminal device 40 establishes a wireless communication between the mobile terminal device 40 and the on-vehicle device 50 when the mobile terminal device 40 has been docked in the dock 30. However, the present invention is not limited to this configuration. For example, the mobile terminal device 40 may establish the wireless communication between the mobile terminal device 40 and the on-vehicle device 50 when the mobile terminal device 40 has proceeded into a predetermined region around a driver's seat.

### DESCRIPTION OF REFERENCE SYMBOLS

1 control device
2 information acquisition device
3 touch panel
4, 4V communication device
5, 5V storage device
6, 6V display device
7 voice input device
8, 8V voice output device
9V position detection device
10 terminal state switching part
11 operation input informing part
12V route guiding part
30 dock
40 mobile terminal device
50 on-vehicle device
51V map database
70 steering wheel
80 speedometer
90 multi information display

1-6. (canceled)

7. A mobile terminal device provided with a touch panel, comprising:
a control device which causes the touch panel to function as an operation input device for an on-vehicle device, that is, as a touch pad for operating an operation object displayed on an on-vehicle display by the on-vehicle device when the mobile terminal device is placed at a predetermined position in a vehicle interior.

8. The mobile terminal device as claimed in claim 7,
wherein the touch panel functions as a multi-touch type touch pad in relation to the on-vehicle display, and
the control device switches operation objects depending on a number of operation points of an operation input performed on the touch panel.

9. The mobile terminal device as claimed in claim 8,
wherein the control device selects one of a cursor, an image of a specific APP, and a widget screen as an operation object depending on a number of fingers used for a touch gesture performed on the touch panel.

10. The mobile terminal device as claimed in claim 7,
wherein the mobile terminal device causes the touch panel to function as a touch pad for the on-vehicle display when a Near Field Communication with an on-vehicle device connected to the on-vehicle display has been established.

11. An on-vehicle device connected to an on-vehicle display,
wherein the on-vehicle device receives an operation input to a touch panel of a mobile terminal device placed at a predetermined position in a vehicle interior as an operation input to an operation object displayed on the on-vehicle display.

12. An on-vehicle system, comprising:
a mobile terminal device provided with a control device which causes a touch panel to function as a touch pad for operating an operation object displayed on an on-vehicle display when the mobile terminal device is placed at a predetermined position in a vehicle interior, and
an on-vehicle device which receives an operation input to the touch panel of the mobile terminal device placed at the predetermined position in the vehicle interior as an operation input to an operation object displayed on the on-vehicle display.
